(19) United States
(12) Patent Application Publication
(10) Pub. No.: US 2004/0143954 A1
(43) Pub. Date: Jul. 29, 2004

(54) System and method including a coil line system and a contour cutting machine and/or a three axis transfer system incorporated into the coil line system for producing metal articles

(76) Inventor: Matthew J. Walsh, Hicksville, NY (US)

Correspondence Address: CHARLES E. BAXLEY, ESQUIRE, Hart, Baxley, Daniels & Holton, Fifth Floor, 59 John Street, New York, NY, 10038, US

(21) Appl. No.: 10/350,872

(22) Filed: Jan. 23, 2003

(51) Int. Cl. B23P 11/00

(52) U.S. Cl. 29/430; 29/33 R

(57) ABSTRACT

A system for producing metal articles. The system includes a coil line system, a contour cutting machine and/or a three axis transfer system incorporated into the coil line system, and first and optional second control computers. The coil line system includes a cradle, an IRS unit/FBS unit, the contour cutting machine, the three axis transfer system, if present, having an operatively connected gripper gantry, a first roll-former, an optional second roll-former, a cleat former/ear bender, a transverse duct connector/transverse duct flange former, an optional insulation system, and a brake system including a brake machine having an operatively connected gripper gantry. The contour cutting machine is operatively connected to the first and optional second, if present, control computers and includes an operatively connected gripper gantry and cutting gantry, and a bed modified to have a pair of reliefs.

### BACKGROUND OF THE INVENTION

1. Field of the Invention

The present invention relates to a system and method for producing metal articles. More particularly, the present invention relates to a system and method including a coil line system and a contour cutting machine and/or a three axis transfer system incorporated into the coil line system for producing metal articles.

2. Description of the Prior Art

The manufacturing of duct requires different types of seams and connections dependent on duct size, pressure, and material gauge thickness. The duct industry has innovated different types of connections and seams over the years. A user, however, with a machine of manufacture predating a particular innovation either becomes obsolete or must be modified to accommodate the innovation. Currently, the machine operator has to adjust for depth on the notching dies manually via a screw adjustment.

Contour-cutting machines can process both strait-duct and fittings, but coil line type machines can only process straight duct. Contour cutting machines have never been incorporated into a strait-duct coil line system. Coil line systems must have an optionally added hole punch station for punching holes in the material for tie rods. The tie rods are used in ducts for strength. Coil stock can be run onto a contour cutting machine, however, there needs to be an operator that guides the material onto the bed of the machine. Coil stock material must be manually placed to either stops or fixed grippers or left in an approximate position and an outer skeleton is left around the patterns that have been cut.

Conveyors, pushers, lift tables, and mechanical guides are used. The material floats through the system. Often times the material becomes caught on the conveyor belts and/or twists and won't reach the mechanical guides or the pushers buckles the material which is most apparent in small size ducts.

Contour cutting unloading systems use the following systems. A fork type system lifts the material off the machine bed. Another system is a suction or magnetic system to lift the material off the machine bed. Finally, a gripper system to pull or push the material off the machine bed. None of these systems, however, have been used in conjunction with coil stock material.

Many different concepts are used in the fabrication of duct work for ventilation, air conditioning, and heating systems. Although practices vary throughout the world, the important factors to be considered in manufacturing ducts are satisfactory air-tightness of the completed duct, vibration-free operation, even flow of air without undue pressure loss in the system, and structural soundness to serve the purpose of conducting heated or cooled air within the system, with a minimum of turbulence and at levels where comfort will not be reduced within the areas to be ventilated.

There are five basic methods of manufacturing ducts based on the position of the seam or fastening lock. The methods include the two piece duct with two corner locks diagonally opposite one another, the one piece wrapper with a single corner lock, the two piece center lock method where two locks are placed at the centers of opposite flat sides, the four piece four lock method where each lock is at the corners, and the two piece duct with one piece shaped as a “U” and the other just a flat side.

In calculating the duct material, the proper type, grade, and thickness of material according to the job that it is designed to handle is selected. The sheet is measured to give the proper width of the completed duct, with proper allowance of metal for the corner joint. Excess material is either trimmed with a shear or slitter.

After the amount of material has been calculated, a notching machine is then used to properly end notch the sheets to the correct depth for the required connectors, as well as to compensate automatically for the amount of material used in the corner notches. This is done by moving the corner head to the zero-datum point and moving the remaining heads to points which are measured by direct tape readings for the proper duct. The sheet is then turned over and the other side is notched. This operation is important since all measurements and bending dimensions are now in the sheet. Greater accuracy and repeatability of correct measurements are insured by this method and squareness of the sheet is maintained. The notching machine will substantially decrease the time of layout over hand or template measurement methods.

Although there are other methods used, the most common methods of forming corner joints (locks) and seams are the Pittsburgh lock and right angle, the Button-Punch Snap Lock, the Double Seam, and the Standing Seam and right angle.

The Pittsburgh lock has been used for over 40 years in the longitudinal jointing of metal at the corner in straight and curved sections for sheet metal duct work in heating, ventilating, and air conditioning systems. It is also used for motor-guards, conveyor systems, and other areas where a tight joint of metal is required. There are various models of machines to form the Pittsburgh lock and right angle flange with 14 gauge though 30 gauge material.

| | | | | | RIGHT |
|---|---|---|---|---|---|
| | | GAUGE | PITTSBURGH | LOCK | ANGLE |
| GAUGE | MACHINE | RANGE | POCKET | ALLOWANCE | FLANGE |
| 14 | ROLLFORMER | 14-18 | ½″ | 1½″ to 1⅜″ | ⅜″ |
| 16 | ROLLFORMER | 16-20 | ½″ | 1½″ to 1¼″ | ⅜″ |
| 18 | ROLLFORMER | 18-22 | ⅜″ | 1¼″ to 1⅛″ | ¼″ |
| 20-22 | ROLLFORMER | 20-26 | 5/16″ | 1″ to 1 5/16″ | 7/32″ |
| 24 | ROLLFORMER | 24-30 | 5/16″ | 1″ to 1 5/16″ | 7/32″ |

The right angle can be produced on straight sections with the right angle flange rolls, which mount to the auxiliary side of the Pittsburgh machine. The right angle flange for elbows, offset, and other various curved sections for companion fittings can also be made on the various power flanging machines, as well as on the manual quarter edger.

| GAUGE RANGE | APPROXIMATE FLANGE |
|---|---|
| 14-24 | ½” to ¼” |
| 16-24 | ⅜” |
| 18-26 | ¼” |
| 20-28 | ¼” |

The Button-Punch Snap Lock is used in the same way as the Pittsburgh lock for joining corner sections of sheet metal. It's big advantage is that no additional “hammer-over” operation is required with a direct result of less labor cost in assembly. It is easier to assemble. The duct can be taken to the job site nested in component form, with a saving in space, and assembled easily on the job site. It is also much quieter in assembly, since no mechanical or air tools are required for hammering over. This lock has been tested for strength and leakage and found to be comparable in all respects to the Pittsburgh lock. This work was performed by the Pittsburgh Testing Laboratories, an independent research laboratory. The results were published in the SMACNA (Sheet Metal and Air Conditioning Contractors National Association, Elgin, Ill.) Duct Manual, and SMACNA has approved its use as an alternate method in its Second Edition 1963 Revised Manual

| MACHINE | GAUGE | MATERIAL USED | |
|---|---|---|---|
| 20 Ga. BUTTON-PUNCH SNAP | 20-26 | 1″ | ¼ |
| LOCK | | | |
| 20 Ga. BUTTON-PUNCH SNAP | 24-30 | 1″ | ¼ |
| LOCK | | | |

The button-punch snap lock flanger is a companion tool to be used with the 20 or 24 gauge BUTTON-PUNCH machines. It produces the curved sections (one directional), outside or inside radius, in a two-step operation on the same machine. This allows the contractor to install a complete Button-Punch job for straight, as well as curved fittings. Range of the machine is 20 to 28 gauge galvanized.

Ducts are commonly joined together by two means: the anchoring Drive Cleat and the reinforcing connector. They are also used in combination, where desirable.

The Drive Cleat is used for anchoring two ducts together, usually on the two narrow sides of ducts that are 18″ or less. In most instances, they will be used with top and bottom reinforcement of a Flat-“S” Cleat or a Standing “S” Cleat section. In fabricating duct and fittings, each section is made up to allow for slightly more than ½ inch of material to extend beyond each end of the section. This material is formed into a 1800 hem. Drive Cleats can also be pre-tabbed. The tab can be bent around the top and bottom of the joint, anchoring the assembly into the final position. Drive Cleat rolls are available for most roll formers. Drive Cleats are typically roll formed in 20 gauge or lighter material. Usual practice is to slit or shear material to 2⅛″ in width and run either tabbed or untabbed pieces to exact size or random lengths.

Numerous innovations for systems and methods for producing round and rectangular strait-duct and fittings have been provided in the prior art. Even though these innovations may be suitable for the specific individual purposes to which they address, they each differ in structure and/or operation and/or purpose from the present invention in that they do not teach a system and method including a coil line system and a contour cutting machine and/or a three axis transfer system incorporated into the coil line system for producing metal articles, such as, but not limited to, round and rectangular strait-duct and fittings, and so as not to be limited to the duct industry, may also include such metal articles as metal building studs, highway guard rails, etc.

### SUMMARY OF THE INVENTION

ACCORDINGLY, AN OBJECT of the present invention is to provide a system and method including a coil line system and a contour cutting machine and/or a three axis transfer system incorporated into the coil line system for producing metal articles that avoid the disadvantages of the prior art.

ANOTHER OBJECT of the present invention is the use of a contour cutting machine and a three-axis transfer system in a coil line system for producing not just duct work, but also for other areas of manufacture, such as metal building studs, highway guardrails, and etc.

STILL ANOTHER OBJECT of the present invention is the use of a three axis transfer system off loading a contour cutting machine that has been loaded with coil stock material.

YET ANOTHER OBJECT of the present invention is the use of a contour cutting machine in a coil line system for the duct work industry, but not limited to just the duct work industry.

STILL YET ANOTHER OBJECT of the present invention is the use of a three axis system in existing shear and notcher type coil line systems for the duct work industry, but not limited to just the duct work industry.

YET STILL ANOTHER OBJECT of the present invention is the use of a three axis transfer system in a coil line system for the duct work industry, but not limited to just the duct work industry.

STILL YET ANOTHER OBJECT of the present invention is the use of a three axis transfer system that feeds roll-formers.

YET STILL ANOTHER OBJECT of the present invention is the use of a three axis transfer system to unload a contour cutting machine that has been loaded with coil stock material.

STILL YET ANOTHER OBJECT of the present invention is to provide a system and method including a coil line system and a contour cutting machine and/or a three axis transfer system incorporated into the coil line system for producing metal articles that are simple to use.

YET STILL ANOTHER OBJECT of the present invention is to provide a coil line system that includes a three axis transfer system that accurately and positively carries a sheet to roll formers, as opposed to existing systems that use conveyors and pushers which let the sheet float.

BRIEFLY STATED, STILL YET ANOTHER OBJECT of the present invention is to provide a system for producing metal articles. The system includes a coil line system, a contour cutting machine and/or a three axis transfer system incorporated into the coil line system, and first and optional second control computers. The coil line system includes a cradle, an IRS unit/FBS unit, the contour cutting machine, the three axis transfer system, if present, having an operatively connected gripper gantry, a first roll-former, an optional second roll-former, a cleat former/ear bender, a transverse duct connector/transverse duct flange former, an optional insulation system, and a brake system including a brake machine having an operatively connected gripper gantry. The contour cutting machine is operatively connected to the first and optional second, if present, control computers and includes an operatively connected gripper gantry and cutting gantry, and a bed modified to have a pair of reliefs.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic top plan view of the system including a coil line system and a contour cutting machine and/or a three axis transfer system incorporated into the coil line system for producing metal articles of the present invention;

FIGS. 2A-2R are a process flow chart of the steps of the method for processing strait-duct; and

FIGS. 3A-3C are a process flow chart of the steps of the method for processing of fittings.

### LIST OF REFERENCE NUMERALS UTILIZED IN THE DRAWING

10 system of present invention for producing metal articles

12 coil line system

14 contour cutting machine of cutting processing center 25

16 cradle of coil line system 12

18 coil stock reels

20 IRS unit/FBS unit of coil line system 12

22 first control computer

24 optional second control computer

25 cutting processing center

26 first gripper gantry of cutting processing center 25

28 pair of arms of first gripper gantry 26 of cutting processing center 25

30 cutting gantry of contour cutting machine 14 of cutting processing center 25

32 bed of contour cutting machine 14 of cutting processing center 25

34 slats of bed 32 of contour cutting machine 14 of cutting processing center 25

36 pair of reliefs in bed 32 of contour cutting machine 14 of cutting processing center 25

38 three axis transfer system of coil line system 12

40 second gripper gantry of coil line system 12

42 pair of arms of second gripper gantry 40 of coil line system 12

44 first roll-former of coil line system 12

46 optional second roll-former of coil line system 12

48 cleat former/ear bender of coil line system 12

50 forming rolls of cleat former/ear bender 48 of coil line system 12

51 conveyor belts of cleat former/ear bender 48 of coil line system 12

52 transverse duct connector/transverse duct flange former of coil line system 12

53 conveyor belts of transverse duct connector/transverse duct flange former 52

54 insulation system of coil line system 12

55 forming rolls of transverse duct connector/transverse duct flange former 52

56 brake system of coil line system 12

58 brake machine of brake system 56 of coil line system 12

60 infeed conveyor belts of brake machine 58 of brake system 56 of coil line system 12

62 third gripper gantry of brake system 56

64 pair of arms of third gripper gantry 62 of brake system 56

### DETAILED DESCRIPTION OF THE INVENTION

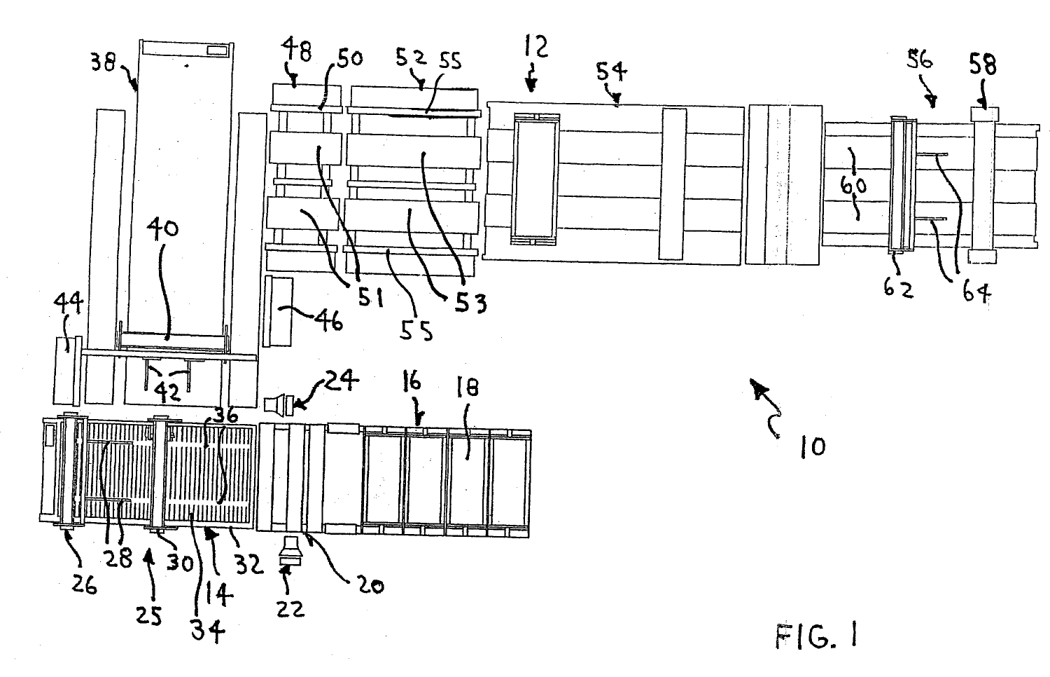

Referring now to the figures, in which like numerals indicate like parts, and particularly to FIG. 1, which is a diagrammatic top plan view of the system including a coil line system and a contour cutting machine and/or a three axis transfer system incorporated into the coil line system for producing metal articles of the present invention, the system of the present invention is shown generally at 10 for producing metal articles. The metal articles may include fittings that include any duct that is not just a straight duct/pipe, but are elbows, transitions, offsets, etc.

The system 10 comprises a coil line system 12 and a contour cutting machine 14. The contour cutting machine 14 is incorporated into the coil line system 12.

The coil line system 12 comprises a cradle 16 that holds coil stock reels 18. Typical examples of the cradle 16 are the Rod-Grid Cradle and the Low Profile Cradle, both by ENGEL INDUSTRIES, 8122 Reilly Ave, St. Louis, Mo. 63111, (314) 638-0110.

The coil line system 12 further comprises an IRS unit/FBS unit 20. The IRS unit/FBS unit 20 are disposed directly subsequent to, and in line with, the cradle 16. A typical example of the IRS unit/FBS unit 20 is the Utilized Compact II Coiline Front End by ENGEL INDUSTRIES, 8122 Reilly Ave, St. Louis, Mo. 63111, (314) 638-0110.

The system 10 further comprises a first control computer 22 and an optional second control computer 24. The first control computer 22 and the optional second control computer 24, if present, has a duct list program either entered thereinto or downloaded thereto. The system 10 operates from the first control computer 22 alone, however, the optional second control computer 24, if present, is for convenience so that the operator can control the system 10 from a location of either the first control computer 22 or the optional second control computer 24, if present.

The system 10 further comprises a cutting processing center 25. The contour cutting machine 14 forms a part of the cutting processing center 25, and is operatively connected to the first control computer 22 and to the optional second control computer 24, if present. The cutting processing center 24 is disposed directly subsequent to, and in line with, the IRS unit/FBS unit 20. The contour cutting machine 14 is plasma, water jet, laser, router, etc. Typical examples of the plasma type contour cutting machine 14 are the Water Table Type Plasma Cutting System, the Model 2000 High Density Plasma Cutting System, and the Model Vicon 8000 HVAC Plasma Cutting system, all by PLASMA AUTOMATION INC., PO Box 550, Hicksville, N.Y. 11802-0550, (516) 822-7067.

The cutting processing center 25 further comprises a first gripper gantry 26. The first gripper gantry 26 is operatively connected to the contour cutting machine 14, and has a pair of arms 28. The pair of arms 28 of the first gripper gantry 26 advance to, and grip, a selected coil of material from the coil stock reels 18, which has been selected from the duct list program either in the first control computer 22 or the optional second control computer 24, if present, so as to form a gripped coil of material. The pair of arms 28 of the first gripper gantry 26 move in concert with each other, and can be vacuum, suction cups, magnetic, gripper clamps, etc., without departing in any way from the spirit of the present invention.

The contour cutting machine 14 has a cutting gantry 30. The cutting gantry 30, commanded from either the first control computer 22 or the optional second control computer 24, if present, cuts a leading notch and a trim cut in the gripped coil of material so as to form an initialized coil of material, which calibrates the gripped coil of material to the first control computer 22 and to the optional second control computer 24, if present.

The contour cutting machine 14 further has a bed 32. The bed 32 of the contour cutting machine 14 has slats 34, and is modified to have a pair of reliefs 36. The slats 34 extend transversely across the bed 32 of the contour cutting machine 14 and are spaced-apart from each other. The pair of reliefs 36 extend longitudinally along in the bed 32 of the contour cutting machine 14 and provide clearance for the pair of arms 28 of the first gripper gantry 26, as the first gripper gantry 26 traverses along the bed 32 of the contour cutting machine 14 and guides the initialized coil of material across the bed 32 of the contour cutting machine 14 so as to maintain material edge location of the initialized coil of material.

The cutting gantry 30 of the contour cutting machine 14 cuts corner notches and trailing notches in the initialized coil of material so as to form a notched sheet of material, and then severs the notched sheet of material so as to form a cut sheet having a length.

The coil line system 12 further comprises a three axis transfer system 38. The three axis transfer system 38 is disposed directly subsequent to, and perpendicular to, the cutting processing center 25.

The three axis transfer system 38 comprises a second gripper gantry 40. The second gripper gantry 40 of the three axis transfer system 38 has a pair of arms 42. The pair of arms 42 of the second gripper gantry 40 advance to, and grip, the cut sheet so as to form a gripped cut sheet, which is then released from the pair of arms 28 of the first gripper gantry 26, and is then removed by the second gripper gantry 40 from the contour cutting machine 14 so as to form a removed cut sheet. The pair of arms 42 of the second gripper gantry 40 move independently of each other so as to avoid the slats 34 in the bed 32 of the contour cutting machine 14 and adjust for the length of the cut sheet, and can be vacuum, suction cups, magnetic, gripper clamps, etc., without departing in any way from the spirit of the present invention.

The coil line system 12 further comprises a first roll-former 44. The first roll-former 44 forms a female seam in an edge of the removed cut sheet so as to form an edge roll-formed sheet by way of the second gripper gantry 40 guiding the removed cut sheet therethrough. The first roll former 44 is disposed adjacent one side of the three axis transfer system 38.

The coil line system 12 further comprises an optional second roll-former 46. The optional second roll-former 46 forms a male Snaplock, a male Pittsburgh, etc. in an opposite edge of the removed cut sheet by way of the second gripper gantry 40 subsequently guiding the removed cut sheet therethrough. The second roll former 46 is disposed adjacent the other side of the three axis transfer system 38.

The coil line system 12 further comprises a cleat former/ear bender 48. The cleat former/ear bender 48 is disposed directly subsequent to, and perpendicular to, the three axis transfer system 38, and has forming rolls 50 and conveyor belts 51. The forming rolls 50 of the cleat former/ear bender 48 carry and form the edge roll-formed sheet into, and therethrough, so as to form a cleat formed/ear bent sheet. The conveyor belts 51 of the cleat former/ear bender 48 carry a non roll-formed edge of the edge roll-formed sheet through the cleat former/ear bender 48. A typical example of the cleat former/ear bender 48 is the Cleat Edge Former by ENGEL INDUSTRIES, 8122 Reilly Ave, St. Louis, Mo. 63111, (314) 638-0110.

The three axis transfer system 38 is a self-contained three axis gripper system that accurately and positively carries, by maintaining a constant grip on, the sheet during seam forming and advancement to the cleat former/ear bender 48, as opposed to existing systems which have separate conveyors and pushers which do not maintain a constant grip on the sheet during seam forming and advancement to the cleat former/ear bender 48, but rather let the sheet float.

The coil line system 12 further comprises a transverse duct connector/transverse duct flange former 52 having conveyor belts 53 and forming rolls 55. The transverse duct connector/transverse duct flange former 52 is disposed directly subsequent to, and in line with, the cleat former/ear bender 48, and has the cleat formed/ear bent sheet carried there onto by the conveyor belts 51 of the cleat former/ear bender 48 so as form a to be formed sheet. The forming rolls 55 of the transverse duct connector/transverse duct flange former 52 carry and form the sheet into the transverse duct connector/transverse duct flange former 52. The sheet receives either a cleat form, a transverse form, or no form as it moves through the system 10. A typical example of the transverse duct connector/transverse duct flange former 52 is the TDF “Snap-Flange” by ENGEL INDUSTRIES, 8122 Reilly Ave, St. Louis, Mo. 63111, (314) 638-0110.

The coil line system 12 further comprises an insulation system 54. The insulation system 54 is disposed directly subsequent to, and in line with, the transverse duct connector/transverse duct flange former 52. The conveyor belts 51 of the transverse duct connector/transverse duct flange former 52 carry the to be formed sheet onto the insulation system 54 where insulation is applied by the insulation system 54 to the to be formed sheet. A typical example of the insulation system 54 is the Lin-O-Matic® Insulation System by ENGEL INDUSTRIES, 8122 Reilly Ave, St. Louis, Mo. 63111, (314) 638-0110.

The coil line system 12 further comprises a brake system 56. The brake system 56 comprises a brake machine 58. The brake machine 58 is disposed directly subsequently to, and in line with, the insulation system 54, and has infeed conveyor belts 60. The infeed conveyor belts 60 of the brake machine 58 carry the to be formed sheet into the brake machine 58 so as to form a brake-ready sheet with a back end. A typical example of the brake machine 58 is the Automatic Brake System by ENGEL INDUSTRIES, 8122 Reilly Ave, St. Louis, Mo. 63111, (314) 638-0110.

The brake system 56 further comprises a third gripper gantry 62. The third gripper gantry 62 is operatively connected to the brake machine 58, and has a pair of arms 64. The pair of arms 64 of the third gripper gantry 62 advance to, and grip, the back end of the brake-ready sheet, and through either the first control computer 22 or the optional second control computer 24, if present, accurately position the brake-ready sheet by virtue of the sheet being previously calibrated to both the first control computer 22 and the optional second control computer 24, if present, and then advance the brake-ready sheet through the brake machine 58 for each bend so as to form the metal article, which the third gripper gantry 62 then ejects out of the brake machine 58. The pair of arms 64 of the third gripper gantry 62 move in concert with each other. A typical example of the brake system 56 is the Full Wrapper Brake System by LOCKFORMER COMPANY, 711 Ogden Avenue, Lisle, Ill. 60532, (630) 964-8000.

Dependent upon article size and processing speed, the system 10 can process more than one metal article at a time. An example would be, the cutting gantry 30 cutting one, while the brake machine 58 is simultaneously bending another.

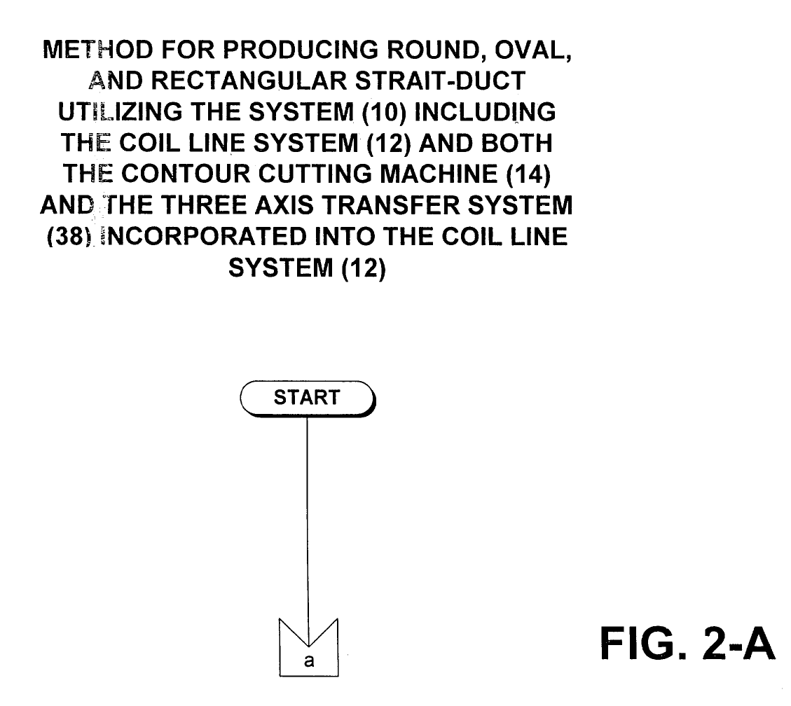

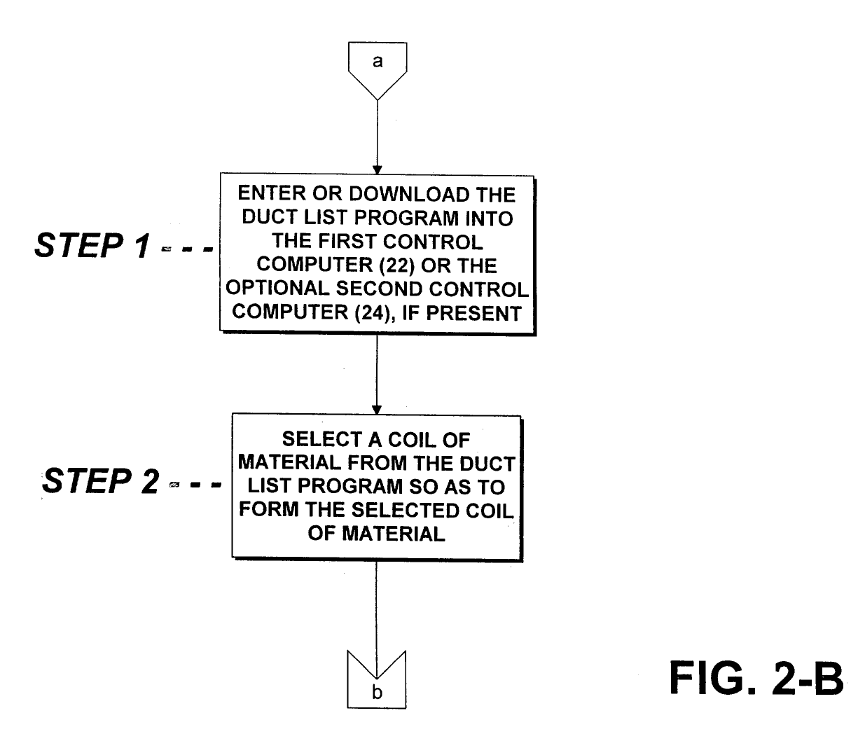

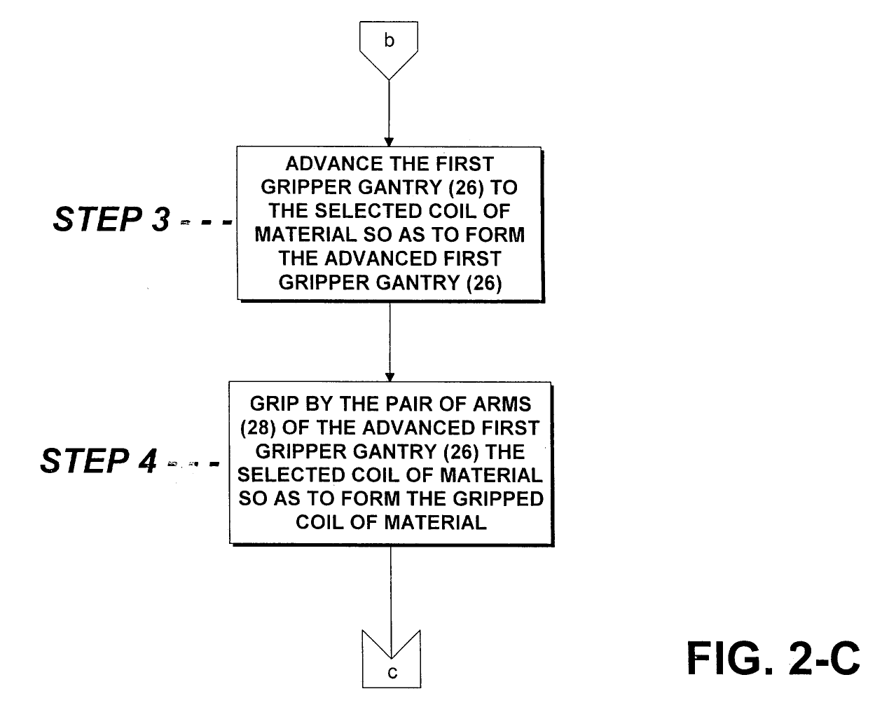

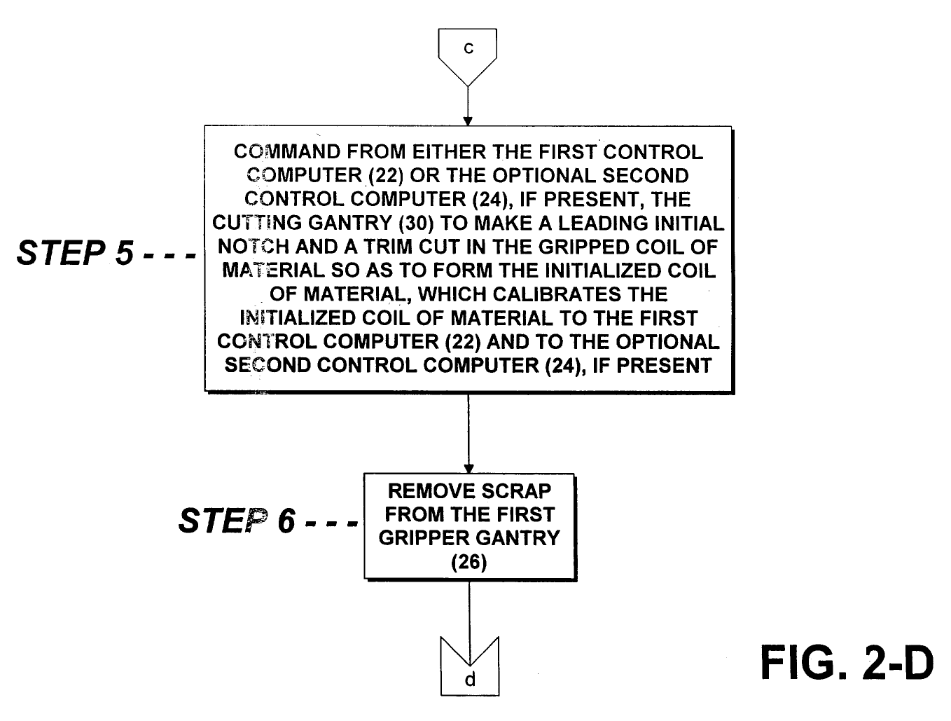

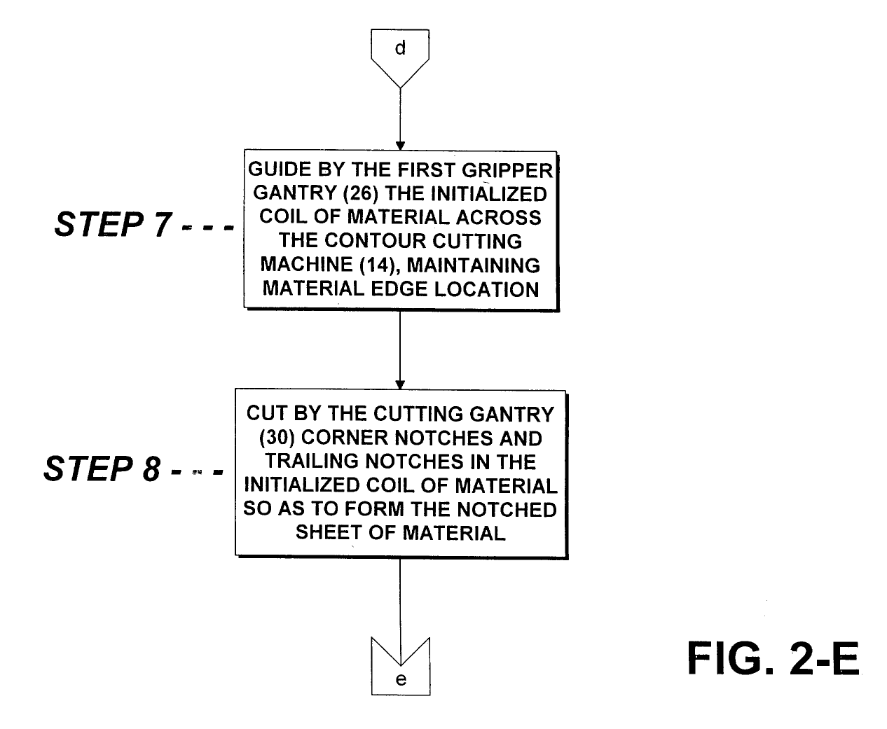

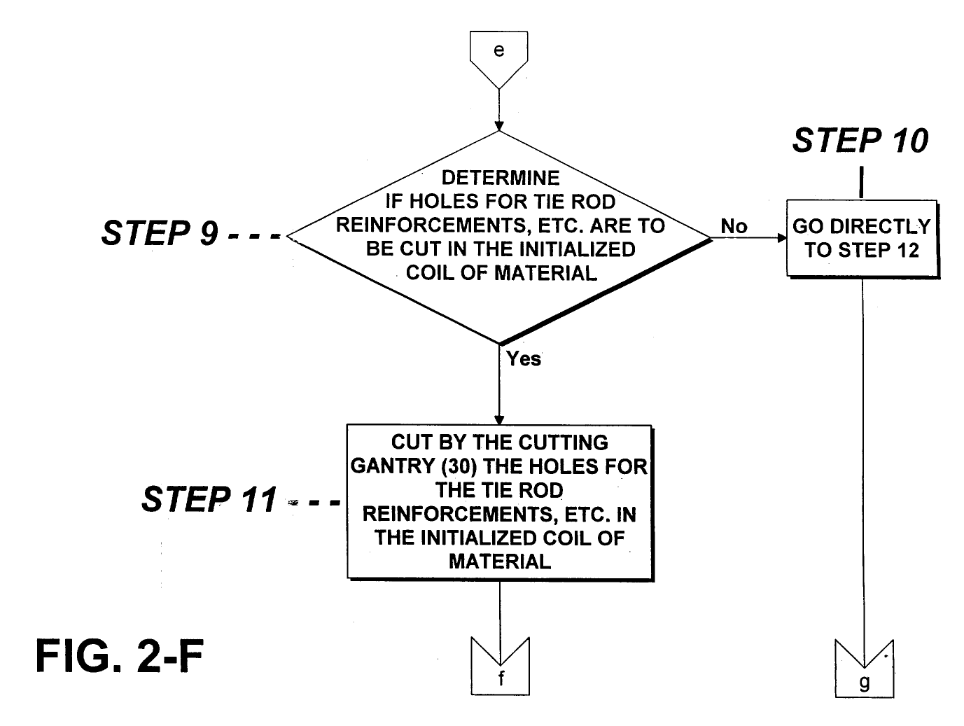

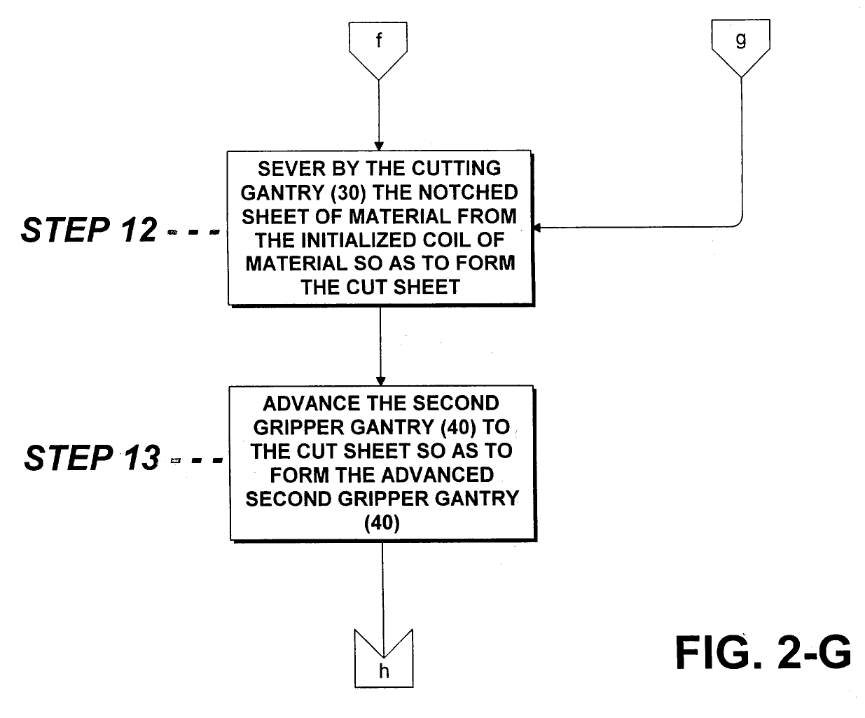

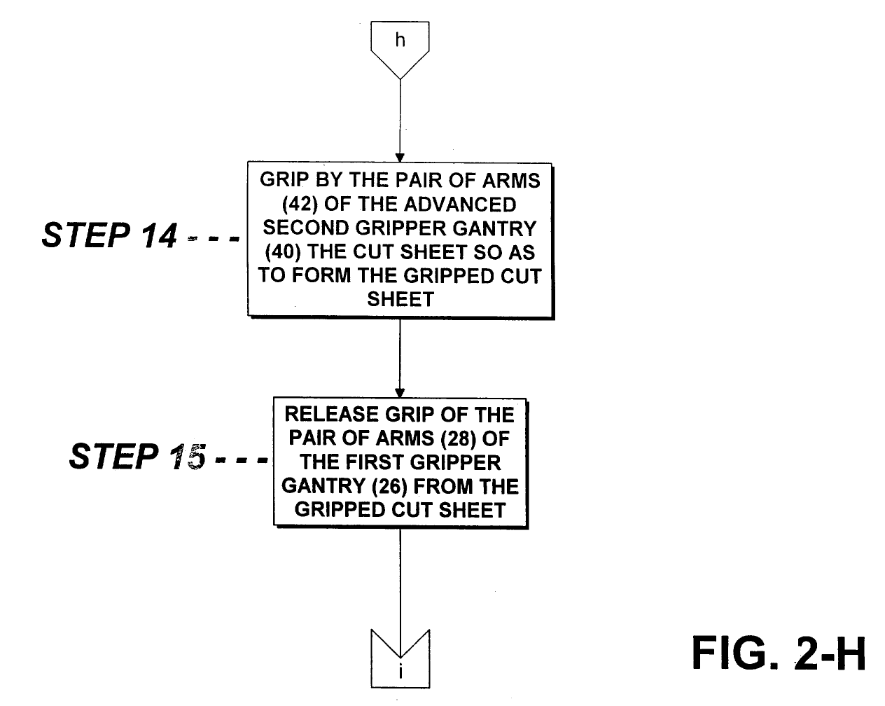

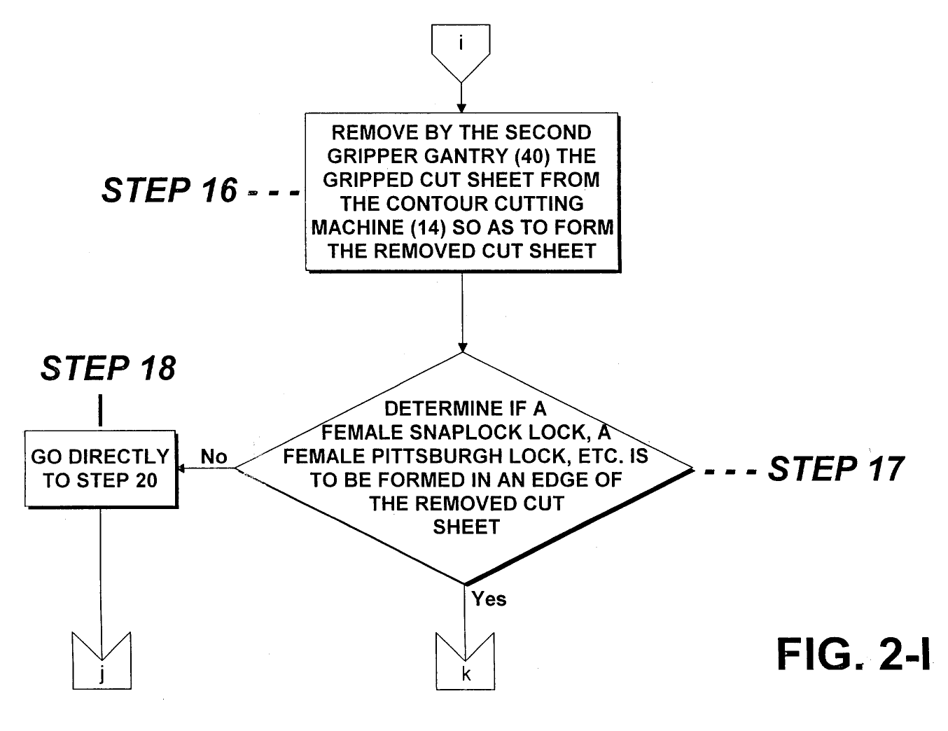

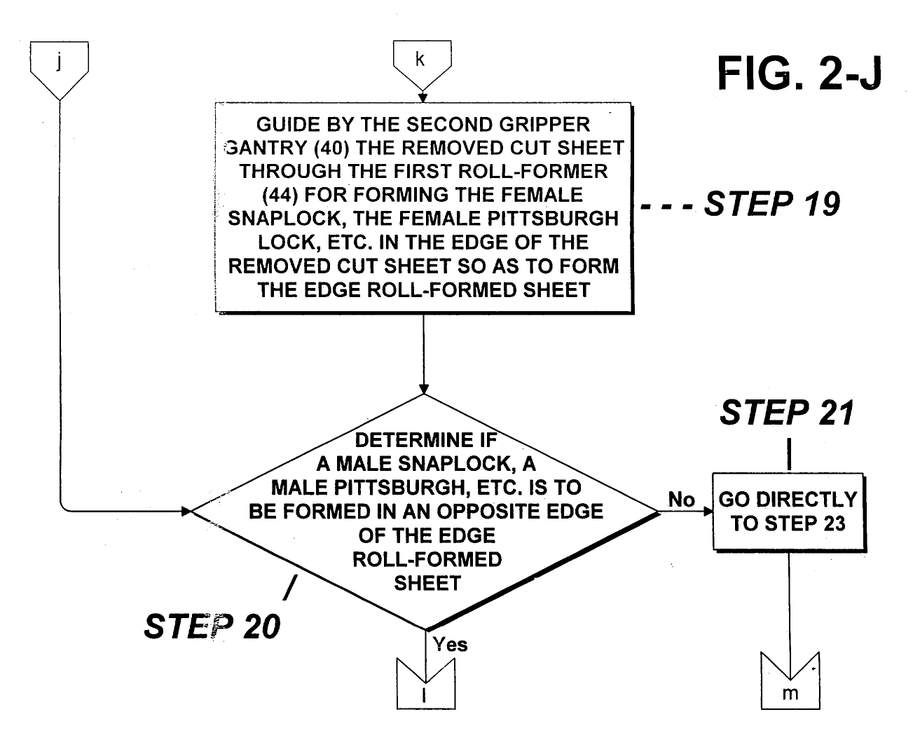

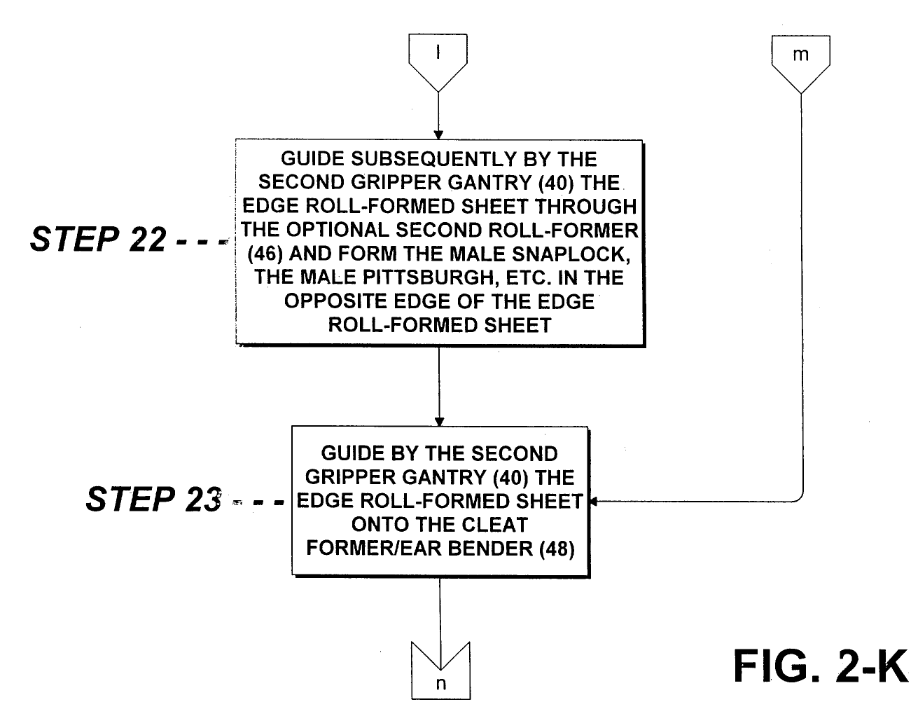

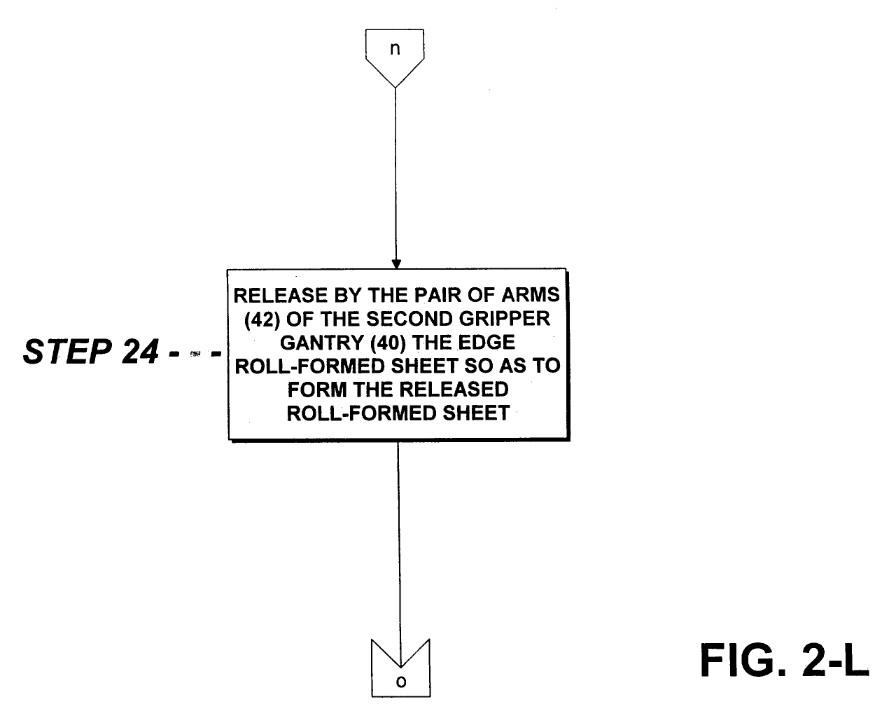

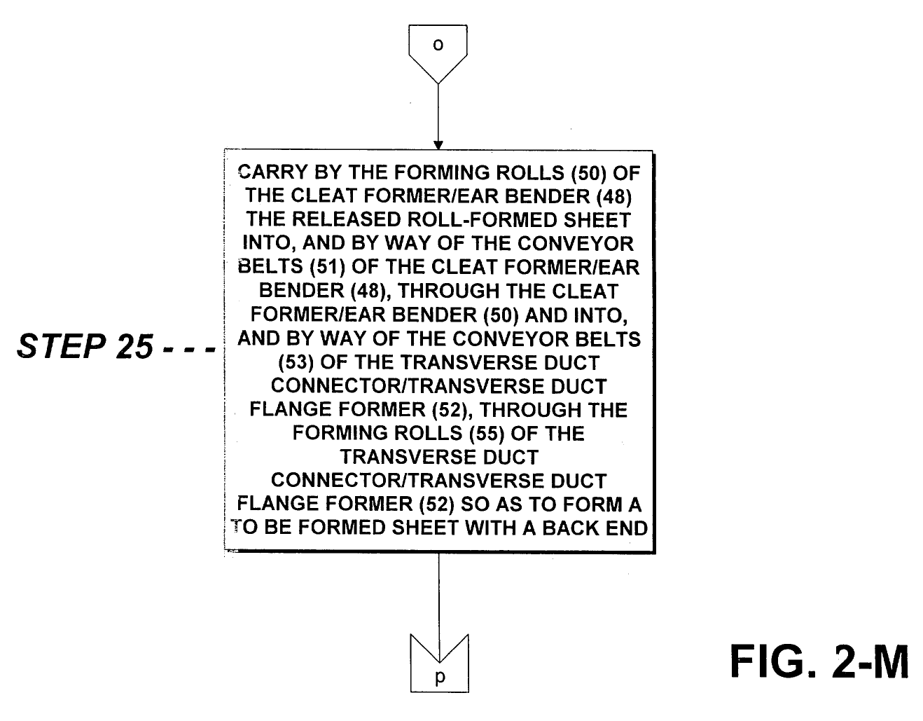

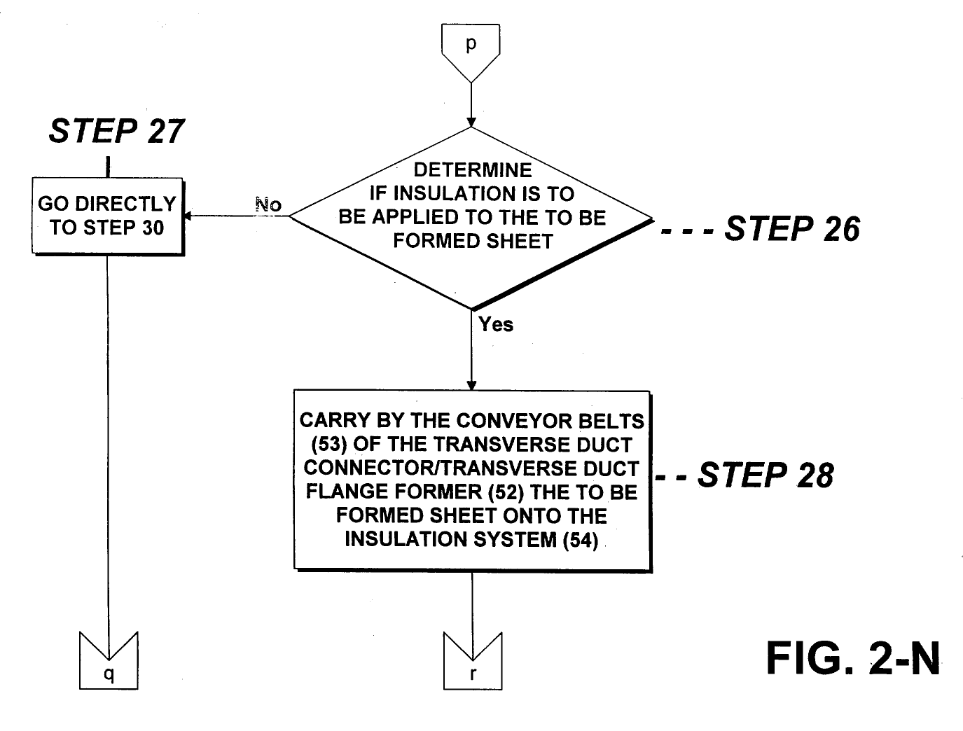

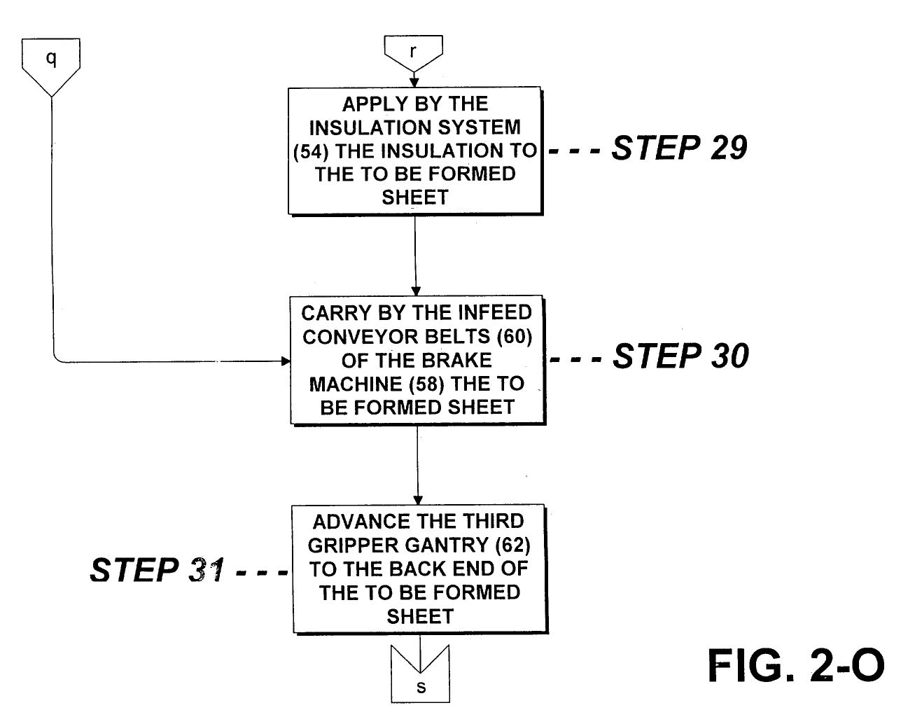

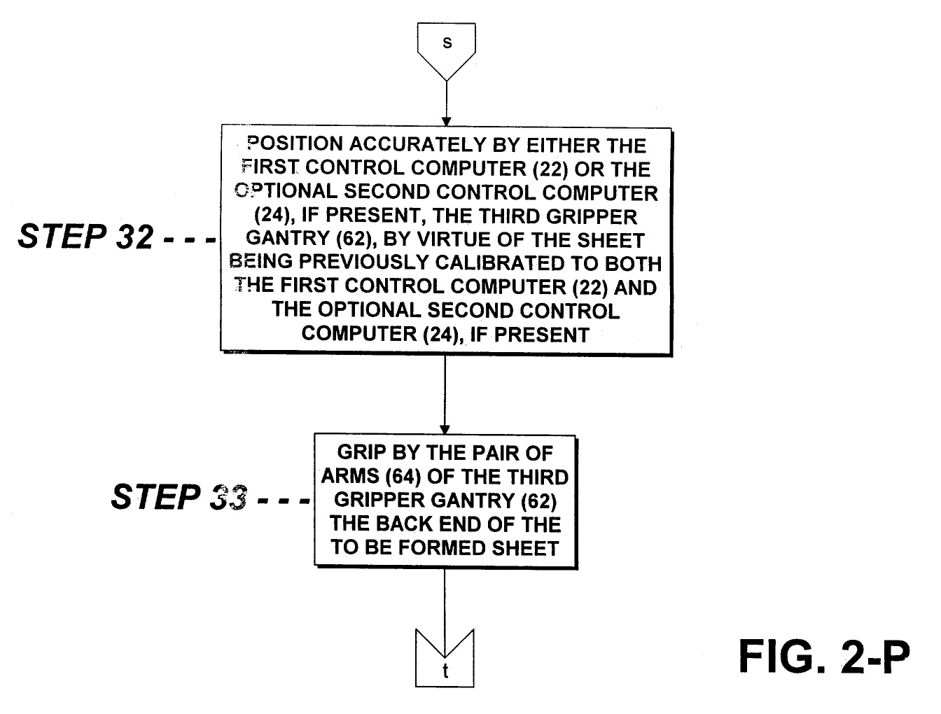

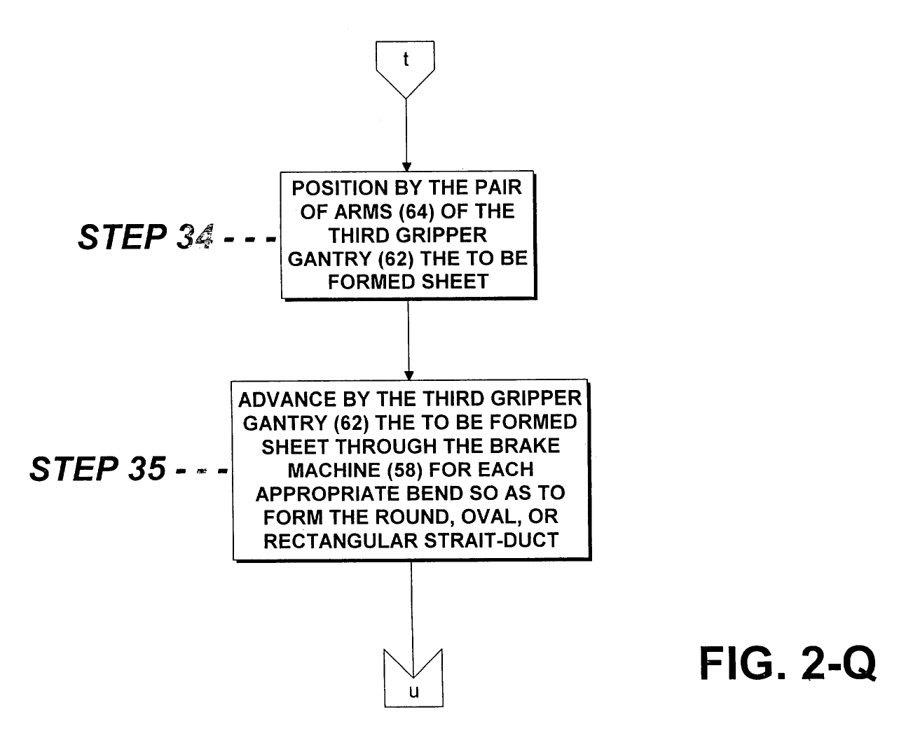

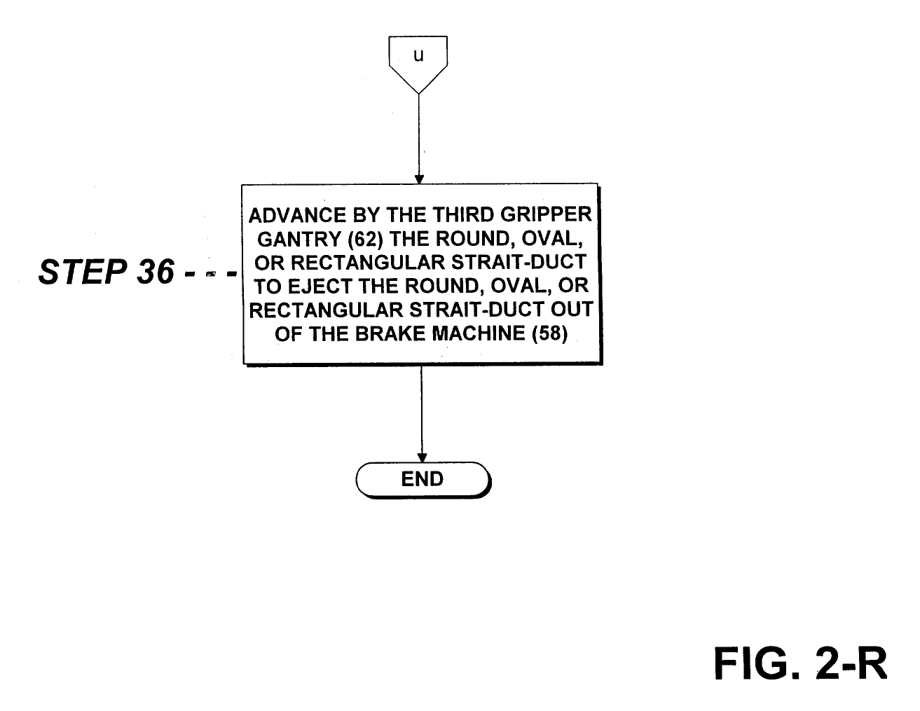

The method for producing the metal article, such as a round, oval, and rectangular strait-duct, utilizing the system 10 including the coil line system 12 and both the contour cutting machine 14 and the three axis transfer system 38 incorporated into the coil line system 12 can best be seen in FIGS. 2A-2R, which are a process flow chart of the steps of the method for processing strait-duct, and as such, will be discussed with reference thereto.

STEP 1: Enter or download the duct list program into the first control computer 22 or the optional second control computer 24, if present.

STEP 2: Select a coil of material from the duct list program so as to form the selected coil of material.

STEP 3: Advance the first gripper gantry 26 to the selected coil of material so as to form the advanced first gripper gantry 26.

STEP 4: Grip by the pair of arms 28 of the advanced first gripper gantry 26 the selected coil of material so as to form the gripped coil of material.

STEP 5: Command from either the first control computer 22 or the optional second control computer 24, if present, the cutting gantry 30 to make a leading initial notch and a trim cut in the gripped coil of material so as to form the initialized coil of material, which calibrates the initialized coil of material to the first control computer 22 and to the optional second control computer 24, if present.

STEP 6: Remove scrap from the first gripper gantry 26.

STEP 7: Guide by the first gripper gantry 26 the initialized coil of material across the contour cutting machine 14, maintaining material edge location.

STEP 8: Cut by the cutting gantry 30 corner notches and trailing notches in the initialized coil of material so as to form the notched sheet of material.

STEP 9: Determine if holes for tie rod reinforcements, etc. are to be cut in the initialized coil of material.

STEP 10: Go directly to STEP 12, if answer to STEP 9 is no.

STEP 11: Cut by the cutting gantry 30 the holes for the tie rod reinforcements, etc. in the initialized coil of material, if answer to STEP 9 is yes.

STEP 12: Sever by the cutting gantry 30 the notched sheet of material from the initialized coil of material so as to form the cut sheet.

STEP 13: Advance the second gripper gantry 40 to the cut sheet so as to form the advanced second gripper gantry 40.

STEP 14: Grip by the pair of arms 42 of the advanced second gripper gantry 40 the cut sheet so as to form the gripped cut sheet.

STEP 15: Release grip of the pair of arms 28 of the first gripper gantry 26 from the gripped cut sheet.

STEP 16: Remove by the second gripper gantry 40 the gripped cut sheet from the contour cutting machine 14 so as to form the removed cut sheet.

STEP 17: Determine if a female Snaplock, lock, a female Pittsburgh lock, etc. is to be formed in an edge of the removed cut sheet.

STEP 18: Go directly to STEP 20, if answer to STEP 17 is no.

STEP 19: Guide by the second gripper gantry 40 the removed cut sheet through the first roll-former 44 for forming the female Snaplock, female Pittsburgh lock, etc. in the edge of the removed cut sheet so as to form the edge roll-formed sheet, if answer to STEP 17 is yes.

STEP 20: Determine if a male Snaplock, a male Pittsburgh lock, etc. is to be formed in an opposite edge of the edge roll-formed sheet.

STEP 21: Go directly to STEP 23, if answer to STEP 20 is no.

STEP 22: Guide subsequently by the second gripper gantry 40 the edge roll-formed sheet through the optional second roll-former 46 and form the male Snaplock, the male Pittsburgh, etc. in the opposite edge of the edge roll-formed sheet, if answer to STEP 20 is yes.

STEP 23: Guide by the second gripper gantry 40 the edge roll-formed sheet onto the cleat former/ear bender 48.

STEP 24: Release by the pair of arms 42 of the second gripper gantry 40 the edge roll-formed sheet so as to form the released roll-formed sheet.

STEP 25: Carry by the forming rolls 50 of the cleat former/ear bender 48 the released roll-formed sheet into, and by way of the conveyor belts 51 of the cleat former/ear bender 48, through the cleat former/ear bender 50 and into, and by way of the conveyor belts 53 of the transverse duct connector/transverse duct flange former 52, through the forming rolls 55 of the transverse duct connector/transverse duct flange former 52 so as to form a to be formed sheet with a back end, wherein the to be formed sheet is either a transverse duct flange formed sheet or a cleat formed sheet.

STEP 26: Determine if insulation is to be applied to the to be formed sheet.

STEP 27: Go directly to STEP 30, if answer to STEP 26 is no.

STEP 28: Carry by the conveyor belts 53 of the transverse duct connector/transverse duct flange former 52 the to be formed sheet onto the insulation system 54, if answer to STEP 26 is yes.

STEP 29: Apply by the insulation system 54 the insulation to the to be formed sheet.

STEP 30: Carry by the infeed conveyors belts 60 of the brake machine 58 the to be formed sheet.

STEP 31: Advance the third gripper gantry 62 to the back end of the to be formed sheet.

STEP 32: Position accurately by either the first control computer 22 or the optional second control computer 24, if present, the third gripper gantry 62 by virtue of the sheet being previously calibrated to both the first control computer 22 and the optional second control computer 24, if present.

STEP 33: Grip by the pair of arms 64 of the third gripper gantry 62 the back end of the to be formed sheet.

STEP 34: Position by the pair of arms 64 of the third gripper gantry 62 the to be formed sheet.

STEP 35: Advance by the third gripper gantry 62 the to be formed sheet through the brake machine 58 for each appropriate bend so as to form the round, oval, or rectangular strait-duct.

STEP 36: Advance by the third gripper gantry 62 the round, oval, or rectangular strait-duct to eject the round, oval, or rectangular strait-duct out of the brake machine 58.

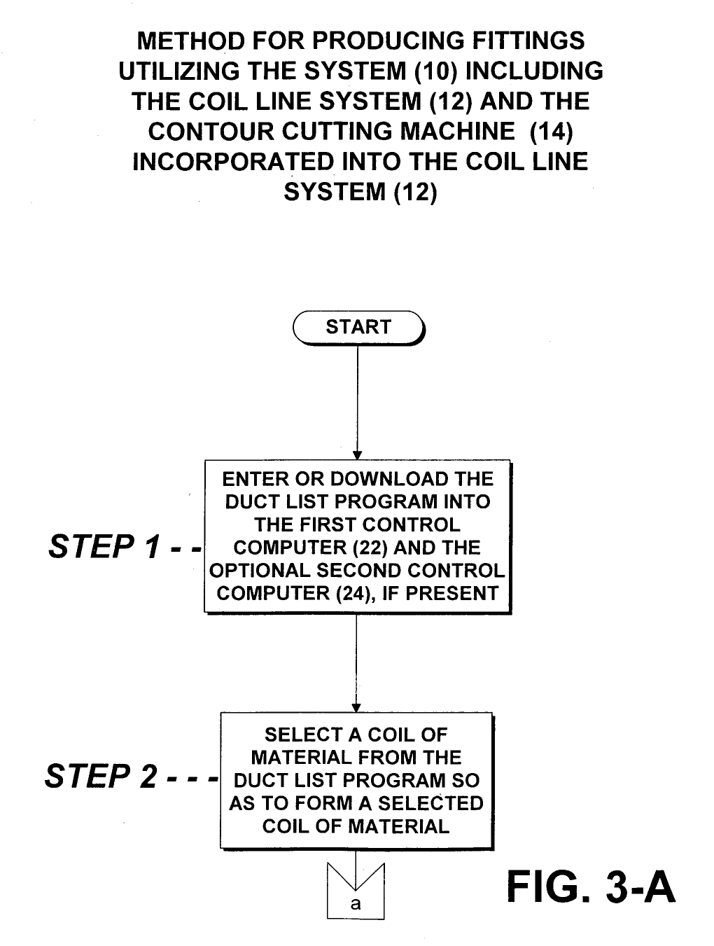

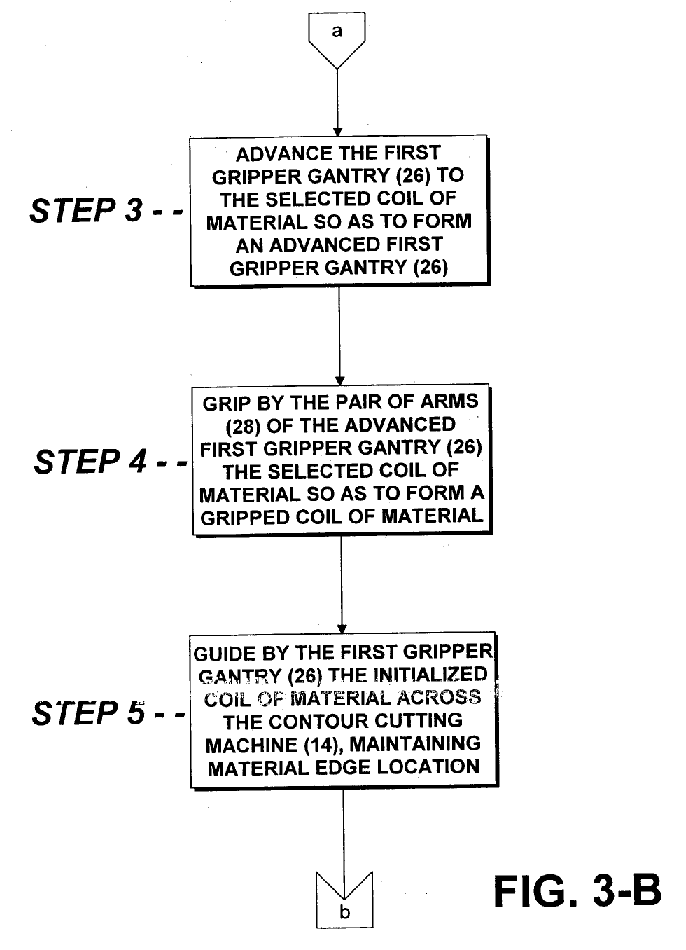

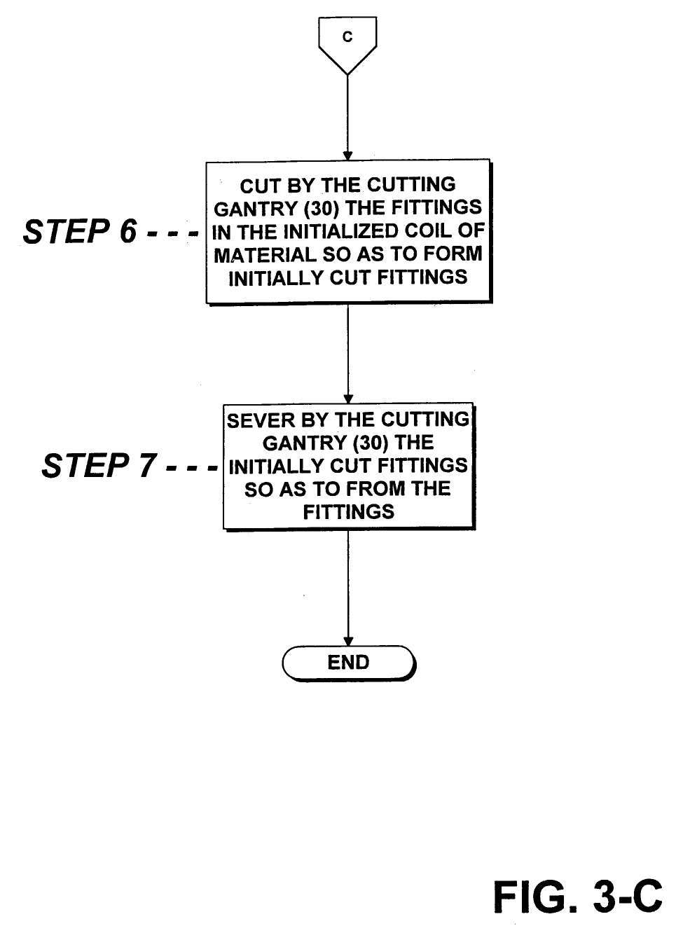

The method for producing the metal article, such as a fitting, utilizing the system 10 including the coil line system 12 and both the contour cutting machine 14 and the three axis transfer system 38 incorporated into the coil line system 12 can best be seen in FIGS. 3A-3C, which are a process flow chart of the steps of the method for processing of fittings, and as such, will be discussed with reference thereto.

STEP 1: Enter or download a duct list program into the first control computer 22 and the optional second control computer 24, if present.

STEP 2: Select a coil of material from the duct list program so as to form a selected coil of material.

STEP 3: Advance the first gripper gantry 26 to the selected coil of material so as to form an advanced first gripper gantry 26.

STEP 4: Grip by the pair of arms 28 of the advanced first gripper gantry 26 the selected coil of material so as to form a gripped coil of material.

STEP 5: Guide by the first gripper gantry 26 the initialized coil of material across the contour cutting machine 14, maintaining material edge location.

STEP 6: Cut by the cutting gantry 30 the fittings in the initialized coil of material so as to form initially cut fittings.

STEP 7: Sever by the cutting gantry 30 the initially cut fittings so as to from the fittings.

It will be understood that each of the elements described above, or two or more together, may also find a useful application in other types of constructions differing from the types described above.

While the invention has been illustrated and described as embodied in a system and method including a coil line system and a contour cutting machine and/or a three axis transfer system incorporated into the coil line system for producing round, oval, and rectangular strait-duct and fittings, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A system for producing metal articles, comprising:
a) a coil line system; and
b) a contour cutting machine;
wherein said contour cutting machine is incorporated into said coil line system.

2. The system as defined in claim 1, wherein said coil line system comprises a cradle; and
wherein said cradle is for holding coil stock reels.

3. The system as defined in claim 2, wherein said coil line system comprises an IRS unit/FBS unit;
wherein said IRS unit/FBS unit are disposed directly subsequent to said cradle; and
wherein said IRS unit/FBS unit are disposed in line with said cradle.

4. The system as defined in claim 3; further comprising a first control computer; and
wherein said first control computer has a duct list program one of entered thereinto and downloaded thereto.

5. The system as defined in claim 4; further comprising a cutting processing center;
wherein said contour cutting machine forms a part of said cutting processing center;
wherein said contour cutting machine is operatively connected to said first control computer;
wherein said cutting processing center is disposed directly subsequent to said IRS unit/FBS unit; and
wherein said cutting processing center is disposed in line with said IRS unit/FBS unit.

6. The system as defined in claim 5, wherein said cutting processing center comprises a first gripper gantry;
wherein said first gripper gantry is operatively connected to said contour cutting machine;
wherein said first gripper gantry has a pair of arms; and
wherein said pair of arms of said first gripper gantry are for advancing to, and gripping, a selected coil of material from the coil stock reels, which has been selected from the duct list program in said first control computer, so as to form a gripped coil of material.

7. The system as defined in claim 6, wherein said pair of arms of said first gripper gantry move in concert with each other; and
wherein said pair of arms of said first gripper gantry are one of vacuum, suction cups, magnetic, and gripper clamps.

8. The system as defined in claim 6, wherein said contour cutting machine has a cutting gantry; and
wherein said cutting gantry, commanded from said first control computer, cuts a leading notch and a trim cut in the gripped coil of material so as to form an initialized coil of material, which calibrates the gripped coil of material to said first control computer.

9. The system as defined in claim 8, wherein said contour cutting machine has a bed;
wherein said bed of said contour cutting machine has slats;
wherein said bed of said contour cutting machine is modified to have a pair of reliefs;
wherein said slats extend transversely across said bed of said contour cutting machine;
wherein said slats are spaced-apart from each other;
wherein said pair of reliefs extend longitudinally along in said bed of said contour cutting machine; and
wherein said pair of reliefs provide clearance for said pair of arms of said first gripper gantry as said first gripper gantry traverses along said bed of said contour cutting machine and guides the initialized coil of material across said bed of said contour cutting machine so as to maintain material edge location of the initialized coil of material.

10. The system as defined in claim 9, wherein said cutting gantry of said contour cutting machine is for cutting corner notches and trailing notches in the initialized coil of material so as to form a notched sheet of material and then severs the notched sheet of material so as to form a cut sheet having a length.

11. The system as defined in claim 10, wherein said coil line system comprises a three axis transfer system;
wherein said three axis transfer system is disposed directly subsequent to said cutting processing center; and
wherein said three axis transfer system is disposed perpendicular to said cutting processing center.

12. The system as defined in claim 11, wherein said three axis transfer system comprises a second gripper gantry;
wherein said second gripper gantry is operatively connected to said three axis transfer system;
wherein said second gripper gantry has a pair of arms; and
wherein said pair of arms of said second gripper gantry are for advancing to, and gripping, the cut sheet so as to form a gripped cut sheet, which is then released from said pair of arms of said first gripper gantry, and removed by said second gripper gantry from said contour cutting machine so as to form a removed cut sheet.

13. The system as defined in claim 12, wherein said pair of arms of said second gripper gantry move independently of each other so as to avoid said slats in said bed of said contour cutting machine and adjust for the length of the cut sheet; and
wherein said pair of arms of said second gripper gantry are one of vacuum, suction cups, magnetic, and gripper clamps.

14. The system as defined in claim 12, wherein said coil line system comprises a first roll-former;
wherein said first roll-former is for forming one of a female Snaplock and a female Pittsburgh in an edge of the removed cut sheet so as to form an edge roll-formed sheet by way of said second gripper gantry guiding the removed cut sheet therethrough; and
wherein said first roll former is disposed adjacent one side of said three axis transfer system.

15. The system as defined in claim 14, wherein said coil line system comprises a second roll-former;
wherein said second roll-former is for forming one of a male Snaplock and a male Pittsburgh in an opposite edge of the removed cut sheet by way of said second gripper gantry subsequently guiding the removed cut sheet therethrough; and
wherein said second roll-former is disposed adjacent the other side of said three axis transfer system.

16. The system as defined in claim 14, wherein said coil line system comprises a cleat former/ear bender;
wherein said cleat former/ear bender is disposed directly subsequent to said three axis transfer system;
wherein said three axis transfer system is a self-contained three axis gripper system that accurately and positively carries, by maintaining a constant grip on, the sheet during seam forming and advancement to said cleat former/ear bender, as opposed to existing systems which have separate conveyors and pushers which do not maintain a constant grip on the sheet during seam forming and advancement to said cleat former/ear bender, but rather let the sheet float;
wherein said cleat former/ear bender is disposed perpendicular to said three axis transfer system;
wherein said cleat former/ear bender has conveyor belts;
wherein said cleat former/ear bender has forming rolls;
wherein said forming rolls of said cleat former/ear bender are for carrying and forming the edge roll-formed sheet into said cleat former/ear bender so as to form a cleat formed/ear bent sheet; and
wherein said conveyor belts of said cleat former/ear bender are for carrying a non roll-formed edge of the edge roll-formed sheet through said cleat former/ear bender.

17. The system as defined in claim 16, wherein said coil line system comprises a transverse duct connector/transverse duct flange former;
wherein said transverse duct connector/transverse duct flange former is disposed directly subsequent to said cleat former/ear bender;
wherein said transverse duct connector/transverse duct flange former is disposed in line with said cleat former/ear bender;
wherein said transverse duct connector/transverse duct flange former has conveyor belts;
wherein said conveyor belts of said cleat former/ear bender are for carrying the non roll-formed edge of the edge roll-formed sheet into said transverse duct connector/transverse duct flange former;
wherein said transverse duct connector/transverse duct flange former has forming rolls; and
wherein said forming rolls of said transverse duct connector/transverse duct flange former are for carrying and forming the edge roll-formed sheet into said transverse duct connector/transverse duct flange former so as to form a to be formed sheet.

18. The system as defined in claim 17, wherein said coil line system comprises an insulation system;
wherein said insulation system is disposed directly subsequent to said transverse duct connector/transverse duct flange former;
wherein said insulation system is disposed in line with said transverse duct connector/transverse duct flange former;
wherein said insulation system is for applying insulation to the to be formed sheet; and
wherein said conveyor belts of said transverse duct connector/transverse duct flange former are for carrying the to be formed sheet onto said insulation system.

19. The system as defined in claim 18, wherein said coil line system comprises a brake system;
wherein said brake system comprises a brake machine;
wherein said brake machine is disposed directly subsequently to said insulation system;
wherein said brake machine is disposed in line with said insulation system;
wherein said brake machine has infeed conveyor belts;
wherein said infeed conveyor belts of said brake machine are for carrying the to be formed sheet into said brake machine so as to form a brake-ready sheet; and
wherein the brake-ready sheet has a back end.

20. The system as defined in claim 19, wherein said brake system comprises a third gripper gantry;
wherein said third gripper gantry is operatively connected to said brake machine;
wherein said third gripper gantry has a pair of arms; and
wherein said pair of arms of said third gripper gantry are for advancing to, and gripping, the back end of the brake-ready sheet, and through said first control computer, accurately position the brake-ready sheet by virtue of the sheet being previously calibrated to said first control computer, and then advance the brake-ready sheet through said brake machine for each bend so as to form one of the round, oval, and rectangular straight-duct, which said third gripper gantry then ejects out of said brake machine.

21. The system as defined in claim 20, wherein said pair of arms of said third gripper gantry move in concert with each other; and
wherein said pair of arms of said third gripper gantry are one of vacuum, suction cups, magnetic, and gripper clamps.

22. The system as defined in claim 1, wherein said contour cutting machine is one of plasma, water jet, laser, and router.

23. The system as defined in claim 20; further comprising a second control computer; and
wherein said second control computer has the duct list program one of entered thereinto and downloaded thereto.

24. The system as defined in claim 23, wherein said contour cutting machine is operatively connected to said second control computer.

25. The system as defined in claim 23, wherein the selected coil of material from the coil stock reels is for being selected from the duct list program in said second control computer.

26. The system as defined in claim 23, wherein said cutting gantry, commanded from said second control computer, cuts the leading notch and the trim cut in the gripped coil of material so as to form the initialized coil of material, which calibrates the gripped coil of material to said second control computer.

27. The system as defined in claim 23, wherein said pair of arms of said third gripper gantry, through said second control computer, accurately position the brake-ready sheet by virtue of the sheet being previously calibrated to said second control computer.

28. A method for producing a metal article utilizing a system including a coil line system and both a contour cutting machine and a three axis transfer system incorporated into the coil line system, wherein the system further includes a first control computer and a second control computer, wherein the contour cutting machine includes a first gripper gantry having a pair of arms, and a cutting gantry, wherein the a three axis transfer system has a second gripper gantry with a pair of arms, and wherein the coil line system includes, a first roll-former, a second roll former, a cleat former/ear bender having forming rolls and conveyor belts, a transverse duct connector/transverse duct flange former having conveyor belts and forming rolls, an insulation system, and a brake machine having infeed conveyor belts and a third gripper gantry with a pair of arms, said method comprising the steps of:
a) one of entering and downloading a duct list program into one of the first control computer and the second control computer;
b) selecting a coil of material from the duct list program so as to form a selected coil of material;
c) advancing the first gripper gantry to the selected coil of material so as to form an advanced first gripper gantry;
d) gripping by the pair of arms of the advanced first gripper gantry the selected coil of material so as to form a gripped coil of material;
e) commanding from one of the first control computer and the second control computer the cutting gantry to make a leading initial notch and a trim cut in the gripped coil of material so as to form an initialized coil of material, which calibrates the initialized coil of material to the first control computer and to the second control computer;
f) removing scrap from the first gripper gantry;
g) guiding by the first gripper gantry the initialized coil of material across the contour cutting machine, maintaining material edge location;
h) cutting by the cutting gantry corner notches and trailing notches in the initialized coil of material so as to form a notched sheet of material;
i) determining if holes for tie rod reinforcements are to be cut in the initialized coil of material;
j) going directly to step 1), if answer to step i) is no;
k) cutting by the cutting gantry the holes for the tie rod reinforcements in the initialized coil of material, if answer to step i) is yes;
l) severing by the cutting gantry the notched sheet of material from the initialized coil of material so as to from a cut sheet;
m) advancing the second gripper gantry to the cut sheet so as to form an advanced second gripper gantry;
n) gripping by the pair of arms of the advanced second gripper gantry the cut sheet so as to form a gripped cut sheet;
o) releasing grip of the pair of arms of the first gripper gantry from the gripped cut sheet;
p) removing by the second gripper gantry the gripped cut sheet from the contour cutting machine so as to form a removed cut sheet;
q) determining if one of a female Snaplock lock and a female Pittsburgh lock is to be formed in an edge of the removed cut sheet;
r) going directly to step t), if answer to step q) is no;
s) guiding by the second gripper gantry the removed cut sheet through the first roll-former for forming the one of the female Snaplock and female Pittsburgh lock in the edge of the removed cut sheet so as to form an edge roll-formed sheet, if answer to step q) is yes;
t) determining if one of a male Snaplock and a male Pittsburgh lock is to be formed in an opposite edge of the edge roll-formed sheet;
u) going directly to step w), if answer to step t) is no;
v) guiding subsequently by the second gripper gantry the edge roll-formed sheet through the second roll-former and form the one of the male Snaplock and the male Pittsburgh in the opposite edge of the edge roll-formed sheet, if answer to step t) is yes;
w) guiding by the second gripper gantry the edge roll-formed sheet onto the cleat former/ear bender;
x) releasing by the pair of arms of the second gripper gantry the edge roll-formed sheet so as to form a released roll-formed sheet;
y) carrying by the forming rolls of the cleat former/ear bender the released roll-formed sheet into, and by way of the conveyor belts of the cleat former/ear bender, through the cleat former/ear bender and into, and by way of the conveyor belts of the transverse duct connector/transverse duct flange former, through the forming rolls of the transverse duct connector/transverse duct flange former so as to form a to be formed sheet with a back end, wherein the to be formed sheet is one of a transverse duct flange formed sheet and a cleat formed sheet;
z) determining if insulation is to be applied to the to be formed sheet;
aa) going directly to step dd), if answer to step z) is no;
bb) carrying by the conveyor belts of the transverse duct connector/transverse duct flange former the to be formed sheet onto the insulation system, if answer to step z) is yes;
cc) applying by the insulation system the insulation to the to be formed sheet;
dd) carrying by the infeed conveyors belts of the brake machine the to be formed sheet;
cc) advancing the third gripper gantry to the back end of the to be formed sheet;
ff) positioning accurately by one of the first control computer and the second control computer the third gripper gantry by virtue of the sheet being previously calibrated to both the first control computer and the second control computer;
gg) gripping by the pair of arms of the third gripper gantry the back end of the to be formed sheet;
hh) positioning by the pair of arms of the third gripper gantry the to be formed sheet;
ii) advancing by the third gripper gantry the to be formed sheet through the brake machine for each appropriate bend so as to form the metal article; and
jj) advancing by the third gripper gantry the metal article to eject the metal article out of the brake machine.

29. A method for producing a metal article utilizing a system including a coil line system and a contour cutting machine incorporated into the coil line system, wherein said system further includes a first control computer and a second control computer, and wherein the contour cutting machine includes a first gripper gantry having a pair of arms, and a cutting gantry, said method comprising the steps of:
a) one of entering and downloading a duct list program into one of the first control computer and the second control computer;
b) selecting a coil of material from the duct list program so as to form a selected coil of material;
c) advancing the first gripper gantry to the selected coil of material so as to form an advanced first gripper gantry;
d) gripping by the pair of arms of the advanced first gripper gantry the selected coil of material so as to form a gripped coil of material;
e) guiding by the first gripper gantry the initialized coil of material across the contour cutting machine, maintaining material edge location;
f) cutting by the cutting gantry the fittings in the initialized coil of material so as to form an initially cut metal article; and
g) severing by the cutting gantry the initially cut metal article so as to from the metal article.

30. A system for off loading coil stock material, comprising:
a) a contour cutting machine; and
b) a three axis transfer system;
wherein said contour cutting machine is for being loaded with the coil stock material;
wherein said three axis transfer system comprises a gripper gantry;
wherein said gripper gantry has a pair of arms; and
wherein said pair of arms of said gripper gantry are for advancing to, and gripping, the coil stock material loaded on the contour cutting machine so as to form gripped coil stock material which said gripper gantry then off loads from said contour cutting machine so as to form off loaded coil stock material.

31. A method for off loading coil stock material utilizing a system including a contour cutting machine and a three axis transfer system, wherein the contour cutting machine has coil stock material loaded thereon, and wherein the three axis transfer system has a gripper gantry with a pair of arms, said method comprising the steps of:
a) advancing the gripper gantry to the coil stock material loaded on the contour cutting machine so as to form an advanced gripper gantry;
b) gripping by the pair of arms of the advanced gripper gantry the coil stock material loaded on the contour cutting machine so as to form gripped coil stock material; and
c) off loading by the gripper gantry the gripped coil stock material from the contour cutting machine so as to form off loaded coil stock material.

32. A system for feeding a sheet, comprising:
a) a three axis transfer system; and
b) at least one roll former;
wherein said three axis transfer system comprises a gripper gantry;
wherein said gripper gantry has a pair of arms; and
wherein said pair of arms of said gripper gantry are for guiding the sheet through the at least one roll former when the at least one roll former is one roll former and are for guiding the sheet consecutively through each roll former when the at least one roll former is more than one roll former.

33. A method for feeding a sheet utilizing a system including a three axis transfer system and at least one roll former, wherein the three axis transfer system has a gripper gantry, said method comprising the step of guiding by the gripper gantry the sheet through the at least one roll-former when the at least one roll former is one roll former and guiding the sheet consecutively through each roll former when the at least one roll former is more than one roll former.
